(19) United States
(12) Patent Application Publication
(10) Pub. No.: US 2026/0076400 A1
(43) Pub. Date: Mar. 19, 2026

(54) AUTOMATED PRODUCE DE-SEEDING AND PULP EXTRACTION MACHINE

(71) Applicant: Vebu Inc., Gardena, CA (US)

(72) Inventors: Siddhant Shivaram, Los Angeles, CA (US); Arthur Francois David Levy, Los Angeles, CA (US); Aaron Lucas, Sherman Oaks, CA (US); Vahid Alizadehyazdi, Long Beach, CA (US); Michael Charles Lui, Cerritos, CA (US); Blake Edward Winner, South Pasadena, CA (US); Amar Keshav Jyothiprakash, Los Angeles, CA (US); Praveen Kumar Nooli, Frisco, TX (US); Celena Staff, Santa Monica, CA (US); Garrett Taylor Dickinson, Los Angeles, CA (US); Curt von Badinski, Burbank, CA (US); Jesse David Lang, Los Angeles, CA (US)

(21) Appl. No.: 19/325,297

(22) Filed: Sep. 10, 2025

Related U.S. Application Data
(60) Provisional application No. 63/694,723, filed on Sep. 13, 2024.
(60) Provisional application No. 63/694,716, filed on Sep. 13, 2024.
(60) Provisional application No. 63/694,293, filed on Sep. 13, 2024.

(51) Int. Cl. A23N 4/22

(52) U.S. Cl. CPC A23N 4/22

(57) ABSTRACT

An automated avocado processing system for cutting an avocado in half, removing the pit, and extracting the flesh from the peel includes a plurality of functional assemblies arranged within an enclosure. Exemplary stations include a loading assembly, cutting coring and pulp extraction station, and food collection assembly. A computer and electronics are programmed and operable to control the automated stations. Related methods are described.

### CROSS-REFERENCE TO RELATED APPLICATIONS

This application claims priority to provisional application No. 63/694,723, filed Sep. 13, 2024, entitled “AUTOMATED PRODUCE DE-SEEDING AND PULP EXTRACTION MACHINE”; provisional application No. 63/694,716, filed Sep. 13, 2024, entitled “Method for Automated Extraction of pulp, juice and other products from an encapsulated fruit, produce, or seed”; and provisional application No. 63/694,293, filed Sep. 13, 2024, entitled “Method and system for singulating and dispensing an object, fruit or produce”, each of which is incorporated by reference in its entirety for all purposes.

### BACKGROUND OF THE INVENTION

### 1. Field of the Invention

This invention relates to food processing systems, and more particularly, to automated food processing systems adapted to automatically feed, singulate, split, core, and extract the pulp from avocados.

### 2. Description of Related Art

In the restaurant environment, various desirable food items such as guacamole are prepared using fresh avocados. The avocados are cut in halves and the pit is removed (hereinafter sometimes referred to as “depitting” or “coring”) by hand. The process relies entirely on employee labor. In addition to being slow, tedious, and prone to injury, the amount and quality of the fruit obtained by the manual process is inconsistent. These shortcomings are exasperated when there is a need to rush or for a large quantity.

Additionally, extracting the usable flesh of the produce from the internal cores/seeds is a labor-intensive process. Flesh yield is often compromised due to the difficulty of the adherence of the flesh to the seed and the rush for deliverables arising in commercial settings.

In order to automate the processing of fresh produce in a commercial kitchen setting, a system is necessary to receive, sort and store the output of the automated processing system. The system must be compact enough to fit within a commercial kitchen while also being able to sort waste products (e.g., the peels) from the edible yield (e.g., the extracted produce flesh).

While some foods can be prepared in advance for an expected rush, there is still a need for fresh preparation of certain food items such as fresh avocado and guacamole. To store avocado and guacamole after they have been prepared reduces the quality of the appearance and taste to some extent. This is undesirable.

There is therefore a need for an improved avocado splitting, coring and pulp extracting system, and particularly, one that is automated and can quickly process multiple avocados for use in the restaurant environment.

### SUMMARY OF THE INVENTION

An automated avocado processing system for cutting an avocado in half, removing the pit, and extracting the flesh from the peel includes a plurality of functional assemblies arranged within an enclosure.

In embodiments of the invention, the functional assemblies include a loading assembly, a cutting, coring and pulp extraction station, and a food collection assembly. A computer and electronics are programmed and operable to control the automated stations.

In embodiments of the invention, a loading assembly comprises a hopper, rotating drum, funnel, and trapdoor assembly. The avocado is singulated by the rotating drum from the hopper, to the funnel, and onto the trapdoor assembly. In embodiments, the trapdoors are opened at a varying speed. In particular embodiments, the trapdoor motion profile is initially high (or fast) and then decreases to low (or a slow motion). The varying speed of the trapdoors serves to tilt and drop the avocado in a desired orientation which, in the case of an ovoid or ellipsoid-shaped object, places its major axis (typically the length) in a horizontal orientation between the opposing trap doors. Alternatively, the trapdoors can be arranged to set the avocado in a vertical orientation or at another angle to horizontal. In embodiments of the invention, the trapdoors open asymmetrically in multiple steps (e.g., each trapdoor opens by a small amount one after the other repeatedly until the full opening is reached by both trapdoors). Further, the trapdoors may partially reverse during these opening motions. These different motion profiles are meant to jostle and roll the fruit within the trapdoors to help move it to a desired orientation.

In embodiments of the invention, a cutting, coring and peeling station comprises a set of clamps to receive the avocado where each clamp includes an upper and lower jaw.

In embodiments of the invention, while receiving the avocado from the trapdoors, the bottom jaws are angled downwards to form a “V” shape, serving to center the avocado core in between the two sets of jaws (in the width direction)

In embodiments, once the fruit has been received the bottom jaws alternate rotating up to a horizontal position then back down to the V position. This action helps align the fruit with its major axis along the cutting plane and center the fruit in between both sets of jaws.

As the left and right clamps rotate in to center on the avocado, the top and bottom jaws are first positioned symmetric to the horizontal plane and then are rotated together until they detect the avocado. This enables centering the avocado core to the top and bottom clamps (in the height direction)

In embodiments, each clamp jaw has sensor feedback and a compliant mechanism. The system detects when an avocado is securely held by the clamps based on a mismatch between the position of the clamp jaw and the actuator as detected by the sensor. Position feedback from the sensor also allows the system to be able to detect the size of the avocado. In embodiments, when the system detects the absence of an avocado, the system triggers an error to report to the operator.

In embodiments of the invention, after the avocado is secured between the upper and lower jaws of each clamp, a blade tool is actuated to cut the avocado in half.

In embodiments of the invention, the left and right side clamps are moved apart while holding each avocado half. Optionally, the clamps can apply a further compression or squishing force to loosen or eject the seed parts from the avocado.

Next, in embodiments of the invention, each clamp is moved across a scraper tool to remove the seed parts from each half. The scraper tool is arranged above a waste bin such that as the seed parts are scraped from each half, they fall into the waste bin.

In embodiments of the invention, each clamp is moved further outwards and above food collection bins. The jaws of each clamp are further compressed to eject the pulp into the food collection bins. Optionally, the jaws of each clamp are moved back and forth relative to each other in a shearing motion to further eject any pulp remnants from the skin.

In embodiments of the invention, an automatic avocado processing system is operable to detect unripe avocados based on the actuator and sensor feedback.

In embodiments of the invention, during the squishing step, the actuator and sensor feedback on the clamps are used to determine if the avocado flesh was able to be extracted. If the flesh was not extracted, the apparatus can trigger an error to the operator to indicate the presence of unripe avocados being processed.

In embodiments of the invention, an automatic avocado processing system is produce-size agnostic based on one or more of the following: a vibration hopper sized to fit one full case of any size avocados; a drum pocket geometry designed to fit a single large size avocado (e.g., size 32) and also disallow more than a single small size avocado (e.g., size 84); trapdoor and clamp lengths sized to accept any size avocado; a knife designed for cutting any size avocado; an auto size detection feature enabling the system to automatically determine the core ejection motion profile appropriate to the size of avocado; auto-centering of the avocado core enabling a size agnostic design of the coring array in a static location; and clamp jaw actuators designed to have enough torque to extract flesh out of any size avocado.

In embodiments of the invention, an automatic produce processing system is operable to provide clean separation and sealing off of food area from actuators, drives and other electronics. In embodiments, the frame is designed with a liner wall that separates all the actuators, drives and other electronics such as sensors, cabling, etc. from the food area. This enables an easy wipedown of the unit. In embodiments, the food area is also designed to be the front and top side of the machine for easy access to clean. This along with quick detachment food contact parts enables one operator to clean the entire unit in under 20 minutes.

In embodiments of the invention, an automatic produce processing system is adapted to fit into any small kitchen and also be easily stored or used in the kitchen as a preparation surface and be compatible with existing commercial kitchens. In embodiments, the system is designed to a footprint of 30″ W×24″ D×34″ H and can be mounted on casters to raise the top lid up to a desired height and increase mobility. In embodiments, the top lid of the apparatus is designed as a flat top surface that is also strong for use as a table top for food preparation and/or storage while the apparatus is operating or dormant.

In embodiments of the invention, the system can be operated from a standard NEMA 5-15p wall outlet. In embodiments, the system integrates a GFCI power cord to prevent electric shocks, electrocutions and burns. This enables easy integration into a kitchen environment low on space and with limited power availability

In embodiments of the invention, an automated produce processing mechanism or assembly is operable to scrape skins to maximize yield. In embodiments, the clamp actuators, after squeezing all the flesh out, are moved away from the avocado to re-open the compliance between the clamp jaws and the clamp actuators and alternately each jaw is pushed against the opposing jaw to eject any leftover flesh in the avocado halve. In a sense this motion replicates scraping the folded skin to extract maximum yield. This enables obtaining maximum yield out of every avocado run through the system.

In embodiments of the invention, an automated produce processing mechanism or assembly is operable to eject the skins. In embodiments, the trapdoors have in-built skin ejector features which can be moved relative to the top jaws to remove leftover skin in the top jaws. In embodiments, the coring array is adapted to eject leftover skin on the bottom jaws by moving the bottom jaws relative to the coring array. Alternatively, a dedicated skin ejection feature can be added to the system such as a passive comb array through which the jaws may be moved or an active system which can be actuated to follow any desired clearing motion.

In embodiments of the invention, a system is programmed and operable to collect data from sensors or otherwise (e.g., time elapsed, count, proximity, load cell data) to create metrics for yield, throughput, etc. In embodiments, the metrics are available or sent to recipients to generate insights related to savings, efficiencies, average consumption, etc.

In embodiments of the invention, the system further comprises a dashboard comprising a plurality of user input features (e.g., levers, knobs, buttons, touch screen, etc.) and indicators (e.g. LEDS, display, audible signals) to control actions (e.g., power, start/stop, speed, avocado size, etc.) and show the status (e.g., on/off, error status) of the system that may prompt the user/operator to interact with the system.

In embodiments of the invention, the system further comprises a computer, power supply, and a plurality of sensors programmed and operable to control the loading, processing, and food collection and holding assemblies.

In embodiments of the invention, the system further comprises a liner wall defining a food processing area and a backend electronics and actuator area to facilitate cleaning the food processing area and protect the electronics and actuator from food contamination.

In embodiments of the invention, the hopper, drum, funnel, trapdoors, jaws, blade, coring array, and bins are removable without the use of tools.

In embodiments of the invention, the cutting assembly is operable to cut through any produce seed/central mass, or eject without cutting through seed/central mass.

In embodiments of the invention, each of the functional assemblies are arranged in a first assembly line in a sequential manner.

In embodiments of the invention, the system further comprises a second assembly line similar to the first assembly line and arranged adjacent or staggered from the first assembly line.

In embodiments of the invention, the objects are individually dispensed into a dedicated lane, rail, or pathway that is driven mechanically, electrically or gravity.

In embodiments of the invention, a method for automatically processing produce comprises carrying out at least one of the following functions: singulating, splitting, coring, ejecting the pulp or peeling, and separating into containers the edible and nonedible parts.

In embodiments of the invention, an automated produce processing system is operable for singulating, orienting, cutting, coring, extracting the pulp, and separating the edible and nonedible parts as described herein.

In embodiments of the invention, the produce is an avocado.

### Objects and Advantages

Objects and advantages of various embodiments of the invention include one or more of the following:

An automated produce processing mechanism or assembly operable to singulate an avocado from a bunch or heap of avocados that can accommodate any size avocado and does not jam.

An automated avocado loading mechanism or assembly operable to modify the degree of vibration of a hopper bin based on detecting the location of an avocado along the processing route.

An automated produce peeling mechanism or assembly operable to separate desired or usable parts of the produce (e.g., avocado flesh) from the waste (e.g., the avocado pit and skin), so as to prevent the waste from contacting or contaminating the usable parts of the produce.

An automated produce peeling mechanism or assembly operable to separate desired or usable parts of the produce (e.g., avocado flesh) from the waste (e.g., the avocado pit and skin) faster and with higher yield than a trained human operator.

An automated produce processing mechanism or assembly having a loading capacity up to a full case of avocados or more.

An automated produce processing mechanism or assembly operable to process different or variations in size and shape of the produce that are typically inherent to fruits/vegetables.

An automated produce processing mechanism or assembly, optionally portable, and including a removable or hinged top cover that is operable to function as a work surface when closed.

An automated produce processing mechanism or assembly operable to process, obtain and track data to compute a wide range of metrics including without limitation flesh yield, total avocados processed, cycle time, and food safety.

An automated produce processing mechanism or assembly adapted to be easily cleaned by one operator and meet standards for food safety.

The description, objects and advantages of the present invention will become apparent from the detailed description to follow, together with the accompanying drawings.

### BRIEF DESCRIPTION OF THE DRAWINGS

FIG. 1 is a right-side isometric view of an automated avocado processing system shown in an open configuration in accordance with an embodiment of the invention;

FIG. 2 is a front view of the automated avocado processing system shown in FIG. 1;

FIG. 3 is an exploded diagram of the automated avocado processing system shown in FIGS. 1-2;

FIG. 4 is a flow chart of a method for processing an avocado in accordance with an embodiment of the invention;

FIGS. 5-8 sequentially illustrate singulating an avocado in accordance with an embodiment of the invention;

FIGS. 9-10 sequentially illustrate cooperating assemblies for clamping the avocado in accordance with an embodiment of the invention;

FIG. 11 illustrates cutting the avocado into halves in accordance with an embodiment of the invention;

FIGS. 12-13 sequentially illustrate coring an avocado half in accordance with an embodiment of the invention;

FIGS. 14A-14C sequentially illustrate ejecting the pulp of an avocado half in accordance with an embodiment of the invention;

FIG. 15 illustrates opening the clamping assembly to release the skin of the avocado into the waste storage in accordance with embodiments of the invention;

FIG. 16 illustrates ejecting any produce remains from the upper and lower clamps respectively;

FIG. 17 is a block diagram of an automated avocado processing system in accordance with an embodiment of the invention;

FIG. 18 is a schematic diagram of a conductor module in accordance with an embodiment of the invention;

FIG. 19 is a software architecture diagram of an avocado processing system in accordance with an embodiment of the invention; and

FIGS. 20A-20B show enlarged perspective views of the right top and right bottom clamps, respectively, in accordance with an embodiment of the invention.

### DETAILED DESCRIPTION OF THE INVENTION

Before the present invention is described in detail, it is to be understood that this invention is not limited to particular variations set forth herein as various changes or modifications may be made to the invention described and equivalents may be substituted without departing from the spirit and scope of the invention. As will be apparent to those of skill in the art upon reading this disclosure, each of the individual embodiments described and illustrated herein has discrete components and features which may be readily separated from or combined with the features of any of the other several embodiments without departing from the scope or spirit of the present invention. In addition, many modifications may be made to adapt a particular situation, material, composition of matter, process, process act(s) or step(s) to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail).

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as an antecedent basis for use of such exclusive terminology as “solely,” “only” and the like in connection with the recitation of claim elements, or use of a “negative” limitation. Last, it is to be appreciated that unless defined otherwise, all technical and scientific terms used herein have the same meaning as commonly understood by one of ordinary skill in the art to which this invention belongs.

### Apparatus Overview

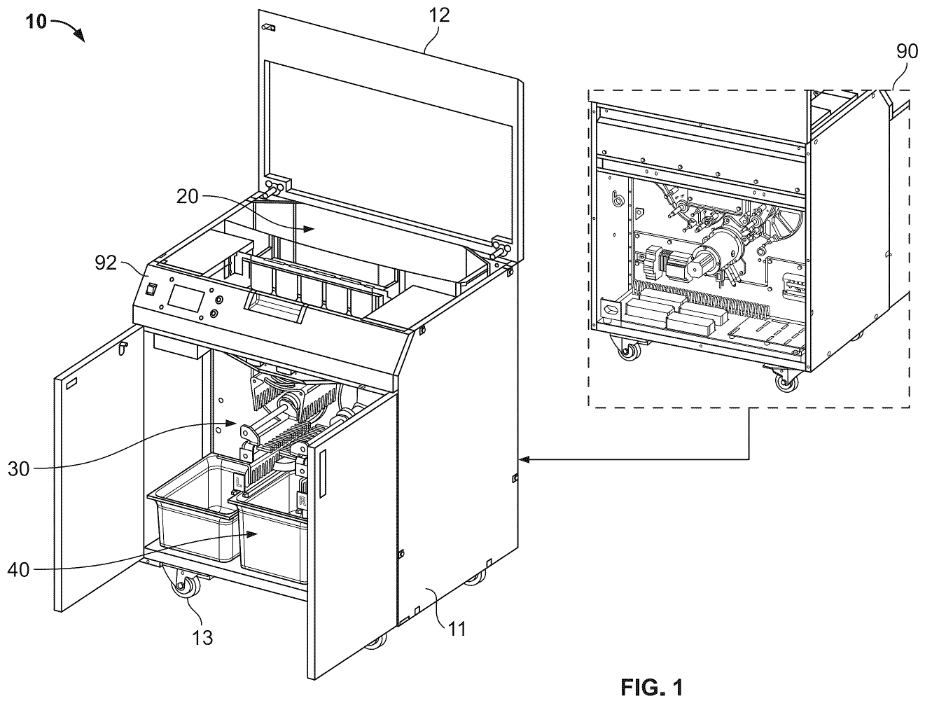

FIG. 1 shows an automated avocado processing system 10 in accordance with an embodiment of the invention. The system 10 has an enclosure or frame 11 including a hinged lid 12 shown in the open configuration. When the lid 12 is closed, the lid can serve as a work surface. Caster wheels 13 are arranged on the feet of the frame to conveniently roll the entire system.

The system 10 is shown having a loading station 20, a cutting, coring and peeling station 30, a food and waste storage station 40, and a computer and electronics enclosure or chamber 90, each of which is discussed herein. In embodiments, a wall separates the rear chamber from the front food processing components.

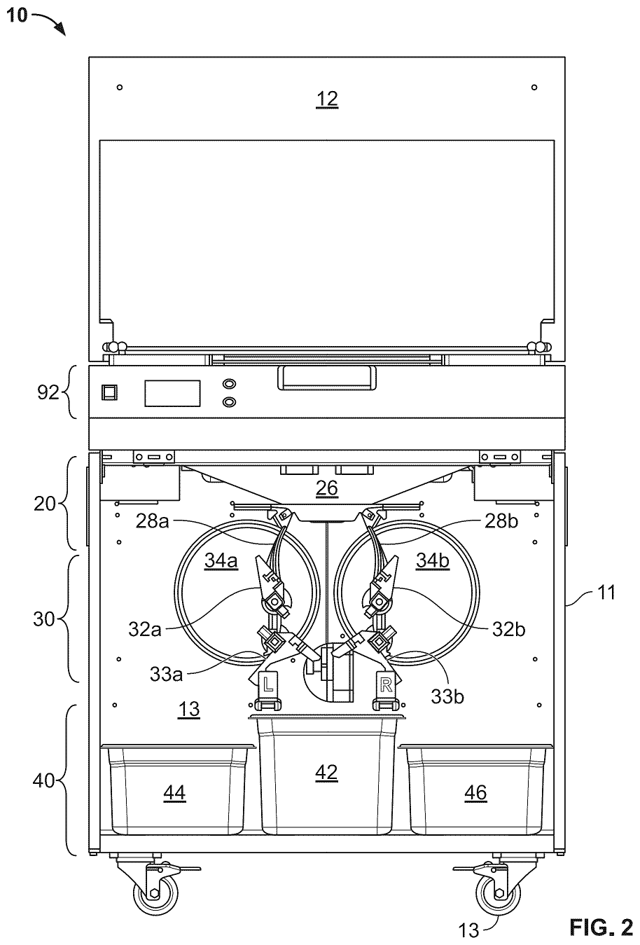

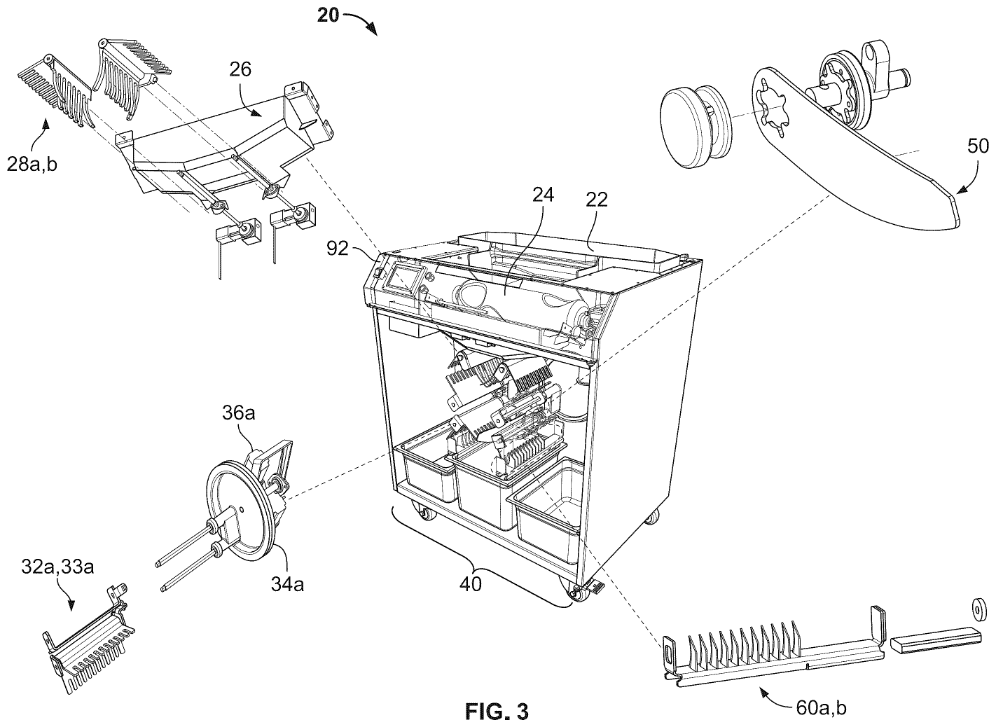

FIGS. 2-3 show the relative internal arrangement of the components of each of the stations.

For embodiments, the loading assembly 20 includes a hopper bin 22, singulation drum 24, funnel 26, and trap doors 28a, 28b arranged below the funnel to receive the avocado.

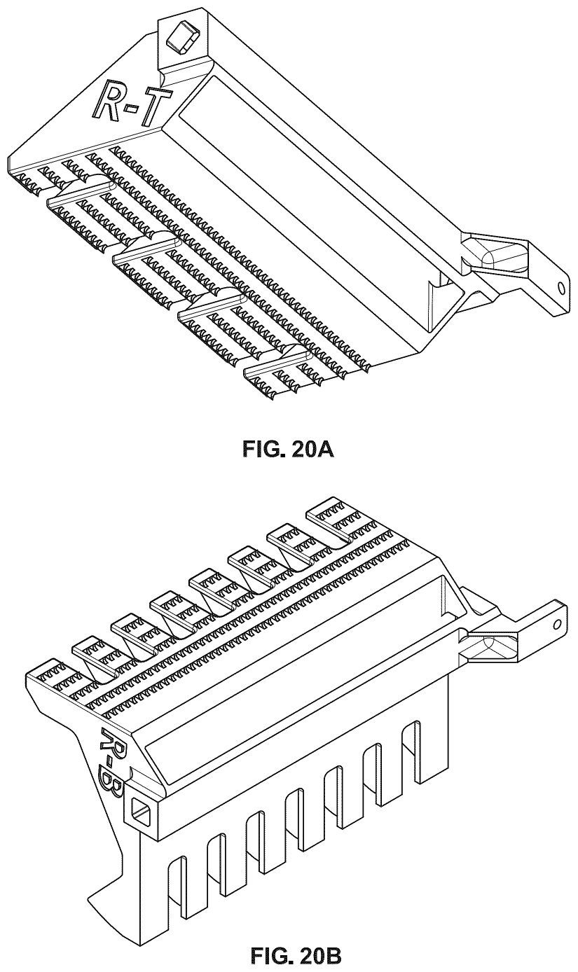

The cutting coring and peeling assembly 30 includes a clamp on the left and right side of the enclosure. The left and right side clamps are arranged side by side in a mirrored fashion. Each of the left and right-side sets contains an upper jaw 32a and lower jaw 33a. The jaws are operable to move relative to one another for clamping onto the avocado. In embodiments, each of the jaw faces have a custom teeth or rasp profile serving to grip and secure the avocado. An enlarged view of the jaws of a right side clamp in accordance with an embodiment of the invention is shown FIGS. 20A-20B. In embodiments, and as described further herein, the clamps are operable to: receive the singulated avocado; center the avocado width wise and height wise; secure the avocado while it is being cut by a tool; and execute a clamping motion to squeeze the flesh out of the cut avocado.

In embodiments, each set of jaws is mounted to the rotating mechanism (rotators 34a, 34b) to move the avocado so as to drop the waste (skin and cores) into the center bin 42 and drop the squeezed flesh into the outer bins 44, 46.

The food and waste holding assembly 40 includes a centrally located waste bin 42 arranged directly below the blade 50, and a flesh bin 44, 46 on each side of the waste bin for receiving the ejected pulp from the separated avocado halves as described further herein. In embodiments, the waste bin is a ½ size standard hotel pan, 8″ deep. In embodiments, the waste bins are ½ size standard hotel pan, 6″ deep.

The computer and electronics 90 are arranged in the rear of the enclosure and separated from the other stations that directly process the avocados by a wall 13. In embodiments, a rear panel to the enclosure 11 is removable to provide convenient access to the computer and electronics.

In embodiments, the computer and electronics 90 include a custom PCB board, multi-axis controller, power supplies, power inlet plug, and actuator drivers.

A control panel or dashboard 92 is also shown on the top of the body 11 including a power switch, emergency stop and various other buttons, lights, indicators, gauges operable with the computer and electronics 90 for controlling operations of the system as described further herein.

Preferably the system is configured to operate on a standard wall outlet plug.

The frame or enclosure 11 is designed to house the above described sub-systems. Embodiments include a number of features including four caster wheels mounted to the bottom of the frame to enhance mobility of the apparatus in the kitchen; a flat top surface for use as a table top for food preparation and/or storage while the apparatus is operating as well as dormant; a top lid to open up and access the feed area to load the machine with a case of avocados; a double door in the front for easy access to the coring cutting and peeling station and the food and waste storage station; a wall for separating the food area from the electronics for ease of cleaning and safety of electronics against food particles, water, cleaning solutions, etc.; and a small footprint under 30″ W×24″ D×38″ H, allowing the system to be able to easily fit in a multitude of kitchen spaces.

### Method for Automatically Processing an Avocado

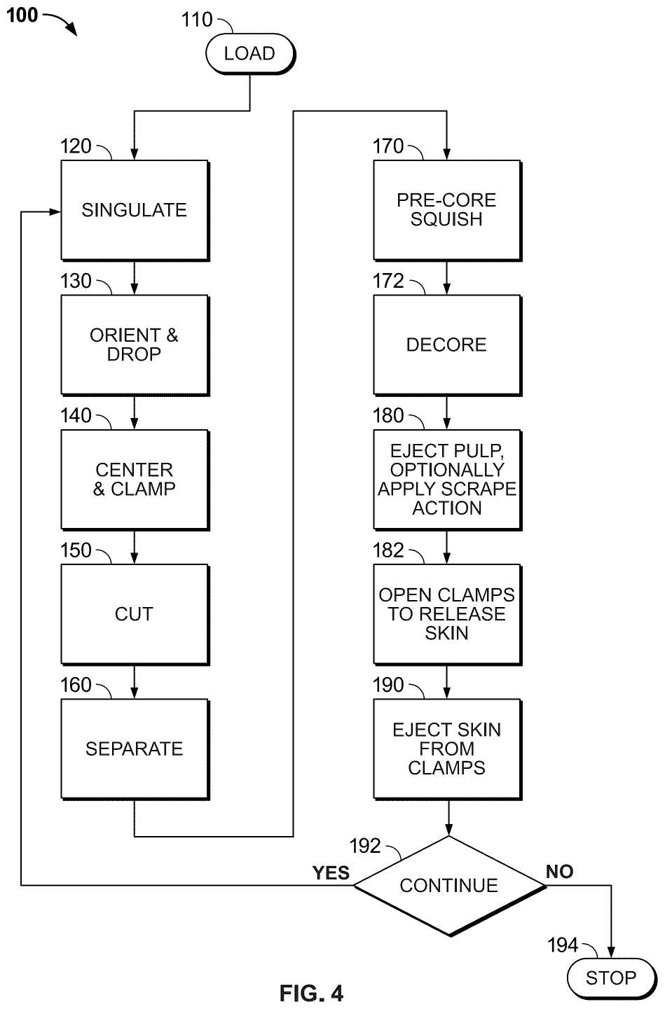

With reference to FIG. 4, an exemplary process 100 for cutting, coring and peeling an avocado is illustrated. In describing the process 100, reference is also made to FIGS. 2, 3, 5-16 for showing various exemplary structures to perform each of the steps of the process.

Step 110 states to load. This step may be carried out by placing one or more avocados in hopper bin 22 shown in FIG. 3. In embodiments, the hopper bin 22 is adapted to store at least a full case worth of avocados, namely, a standard 25 lb. case of avocados of any size or shape from any supplier.

The hopper bin feeds the avocados into a rotating drum 24, discussed further herein in connection with step 120. In embodiments, the hopper is further operable to vibrate to facilitate movement of the avocados towards the rotating drum. An example of a vibrating hopper system for singulating a produce is described in provisional application number 63/694,293, filed Sep. 13, 2024, entitled “Method and system for singulating and dispensing an object, fruit or produce”, which is herein incorporated by reference in its entirety for all purposes.

Step 120 states to singulate. This step is performed by singulating an avocado from the batch of avocados in the hopper bin 22. For embodiments, avocados from the hopper bin 22 are fed by way of vibration towards the rotating drum 24 which includes a plurality of axially-spaced pockets, each of which is sized to singulate any size avocado.

Optionally, a curtain (not shown) is arranged on the upstream side of (and above) the drum to ensure avocados can only be translated forward through the drum pockets, and not over the top of the drum.

The singulating drum 24 begins to rotate to dispense a single avocado into the funnel 26, discussed herein.

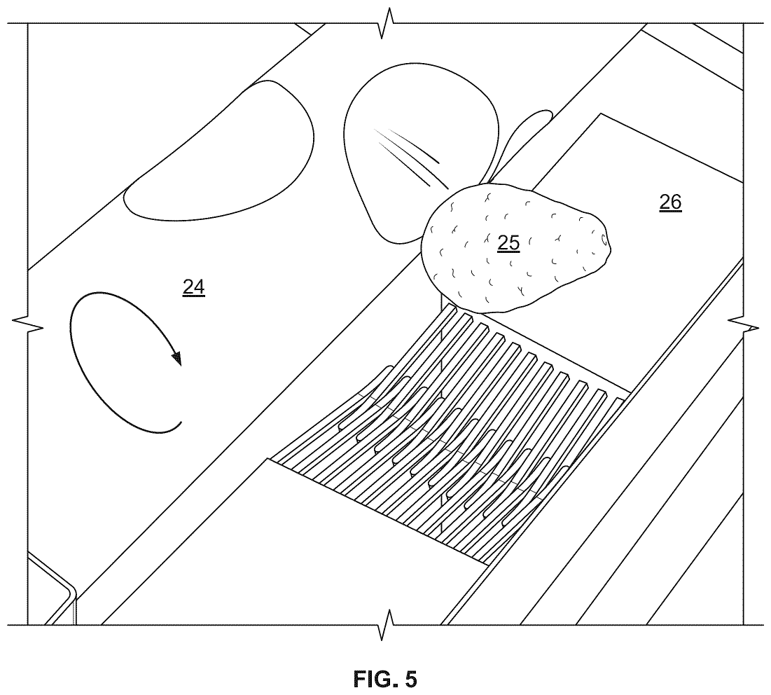

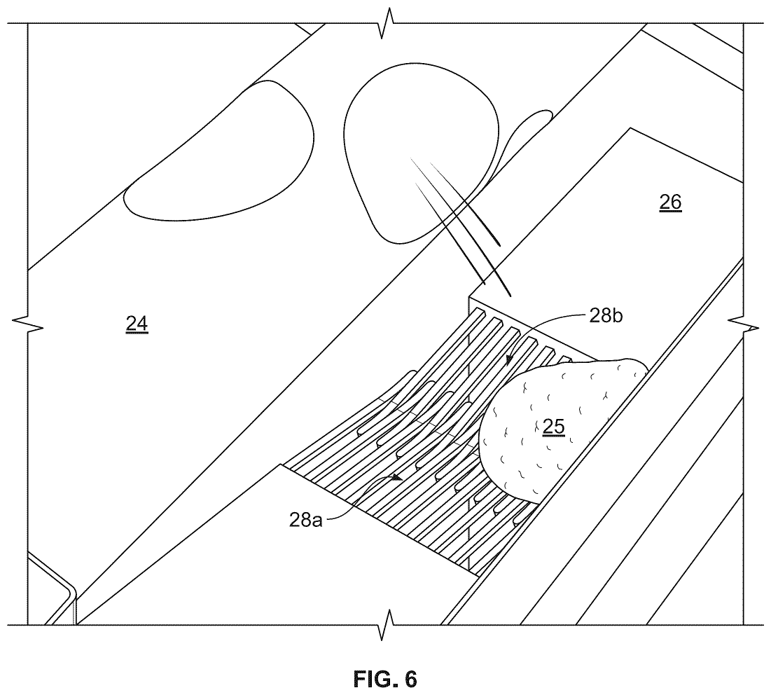

With reference to FIGS. 5-6, the rotating drum 24 is shown translating an avocado 25 from the hopper to the funnel 26, and ultimately to the centrally located trapdoors 28a, 28b.

The trapdoors 28a, 28b serve to stage the avocado 25 and then drop it into a target processing area for the cutting, coring and peeling, discussed herein.

The trapdoors 28a, 28b are shown having interlocking fingers and collectively forming a concave bow-like shape serving to center the avocado 25 onto the processing area of the cutting coring and peeling assembly 30.

In embodiments, the fingers of the trapdoors 28a, 28b are shaped and arranged to mechanically cooperate with gaps in the upper jaws 32a, 32b to eject the spent avocado skins from the upper jaws after the avocado pulp has been ejected, discussed further herein.

Step 130 states to orient and drop. For embodiments, the trapdoor geometry and motion facilitate accurate orientation of the avocado 25 onto the processing area of the coring cutting and peeling (C2P). When the C2P assembly 30 is ready to process an avocado, the trapdoors 28a, 28b are rotated open. In embodiments, the motion profile for opening the trapdoors varies. In a preferred embodiment, the motion profile is initially fast, and then slows down just before releasing the avocado. This urges the avocado into a horizontal orientation for improved flesh extraction from the C2P assembly 30.

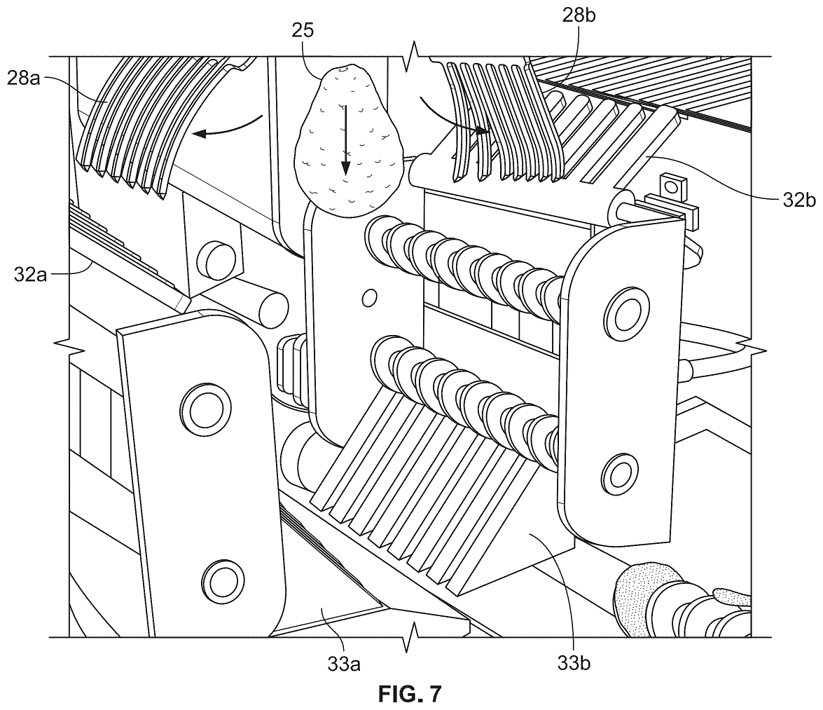

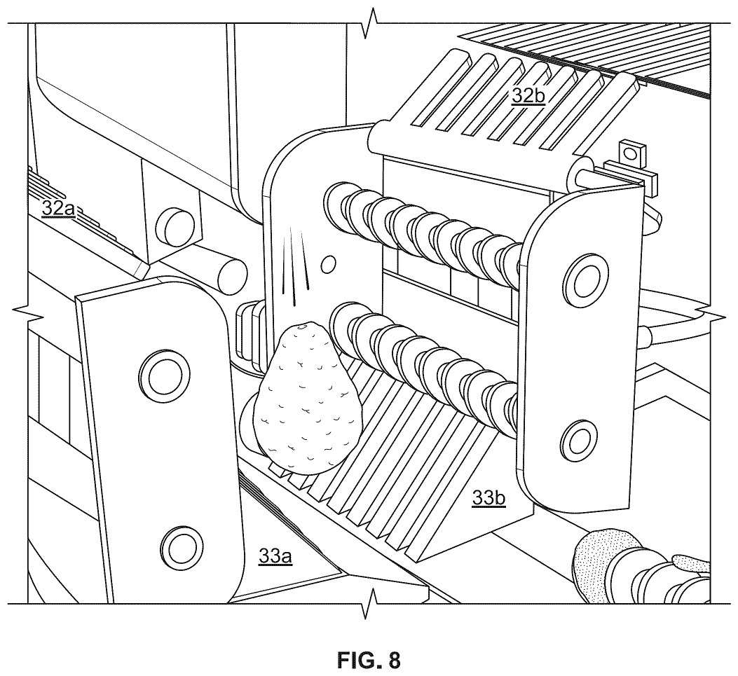

With reference to FIGS. 7-8, the trapdoors continue to open, dropping the avocado onto the processing area of the C2P assembly.

Step 140 states to center and clamp.

With reference to FIG. 8, the left and right side clamps are arranged to receive the avocado where bottom jaws 33a, 33b are angled downwards to form a “V” shape and the top jaws 32a, 32b are rotated out of the way. The V-shaped catch enables the orientation of the avocado to be maintained as horizontal and enables centering of the core in between the both sets of clamps (in the width direction).

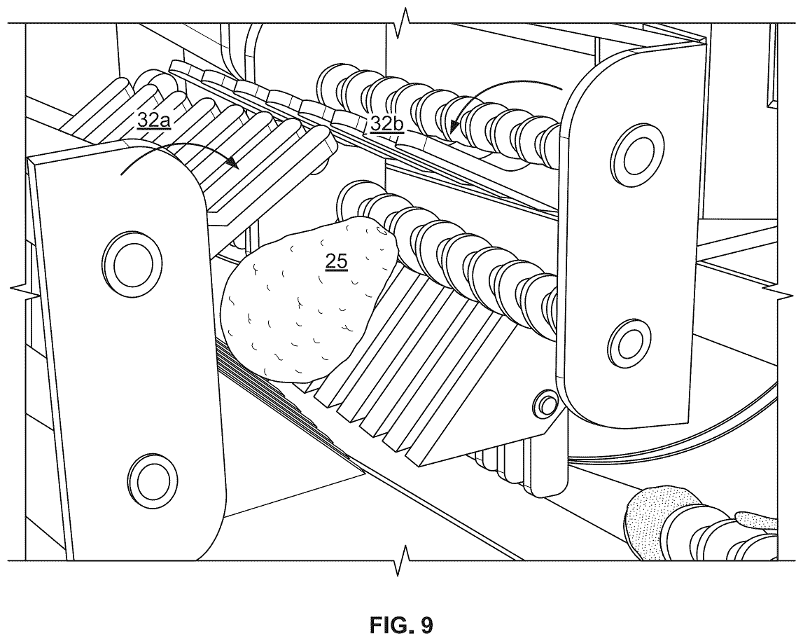

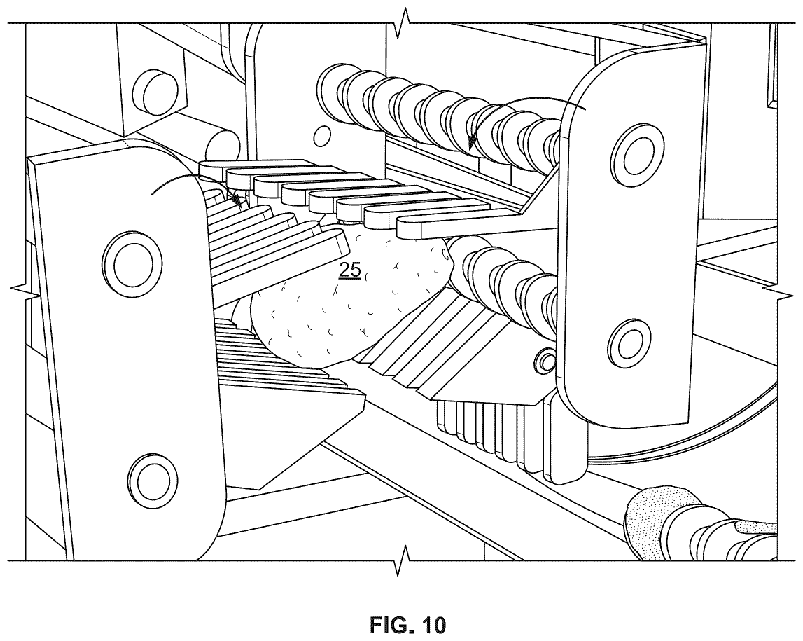

With reference to FIGS. 9-10, the top jaws 32a, 32b then rotate towards the avocado until they match the bottom jaws in the angle from horizontal. The top and bottom jaws then move together towards the avocado until the system determines that the avocado is securely held by all 4 clamps.

In embodiments, each jaw has sensor feedback mounted to the back of the shaft upon which the jaw is fixed and has a compliant mechanism (e.g., a resilient or spring member) in between the jaw's actuator and the shaft to both provide gripping pressure onto the avocado and detect for the presence of an avocado being clamped. A sensor can monitor the displacement of the jaw relative to the actuator (e.g., LT jaw 32a to actuator 36a as shown in FIG. 3). When the jaw is driven into the avocado by the actuator it will at first be stopped in its motion by the avocado while the actuator continues turning until there is no more compliance left between the actuator and the jaw. The sensor detects by which amount the actuator has continued moving while the jaw was stationary. The computer is pre-loaded with the designed amount of compliance such that when the sensor reads the difference in motion between jaw and actuator to be the designed amount of compliance, the system determines that the avocado is securely held by the jaws. An example of a type of sensor is an encoder such as CUI Devices' AMT103.

In embodiments, the size of the avocado can be computed based on the position feedback from the sensor.

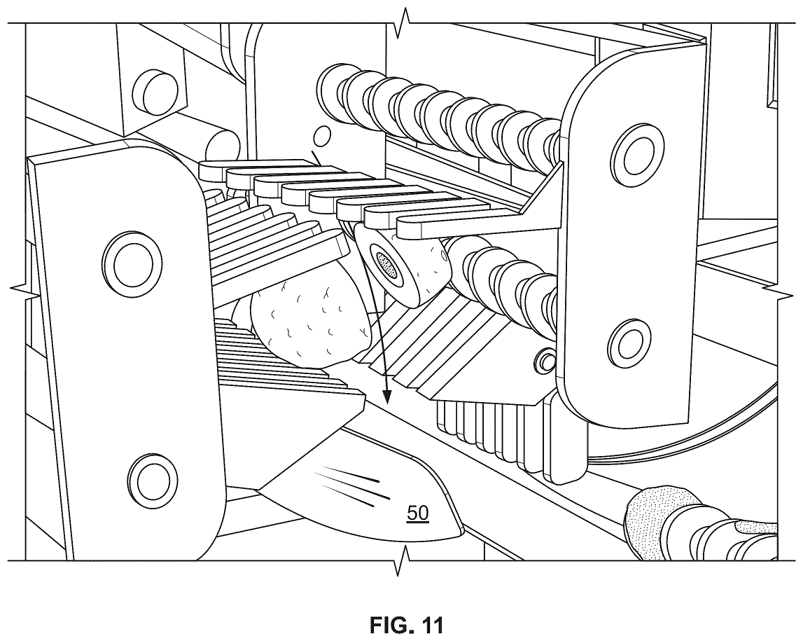

Step 150 states to cut. This step may be performed, with reference to FIG. 11, by driving a tool (e.g., blade 50) through the center of the avocado to cut the avocado into halves (including cutting the core into halves).

Step 160 states to separate. This step is performed by outwardly rotating the rotators 34a, 34b as each set of jaws continues to hold onto a portion of the avocado arising from cutting step 150.

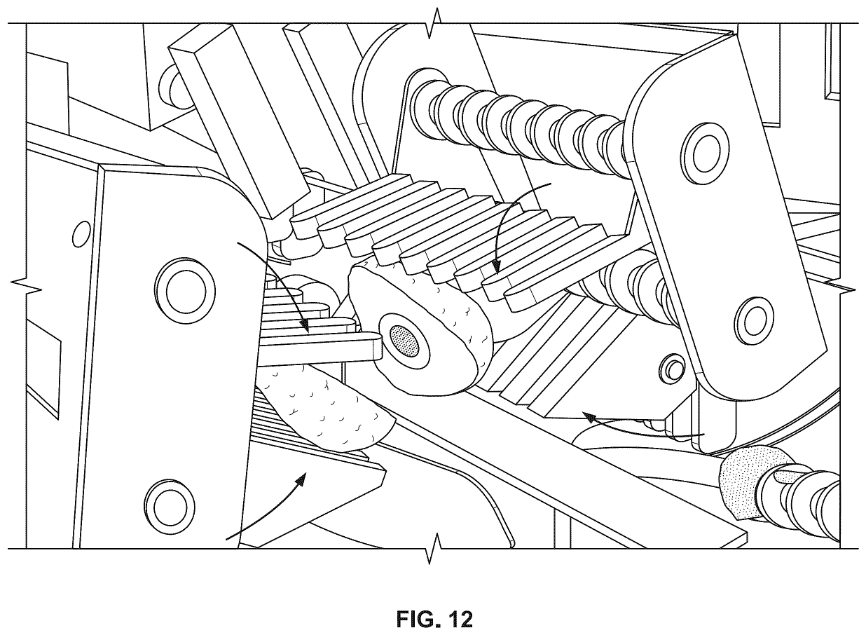

Step 170 states to “pre-core squish”, which will loosen/eject the core. Based on the size detected from Step 140, each set of the left and right side jaws apply pressure to each avocado half to loosen and/or eject the core of the avocado as shown in FIG. 12 by moving into the avocado half by 5 to 10 degrees proportionally to the size of the avocado

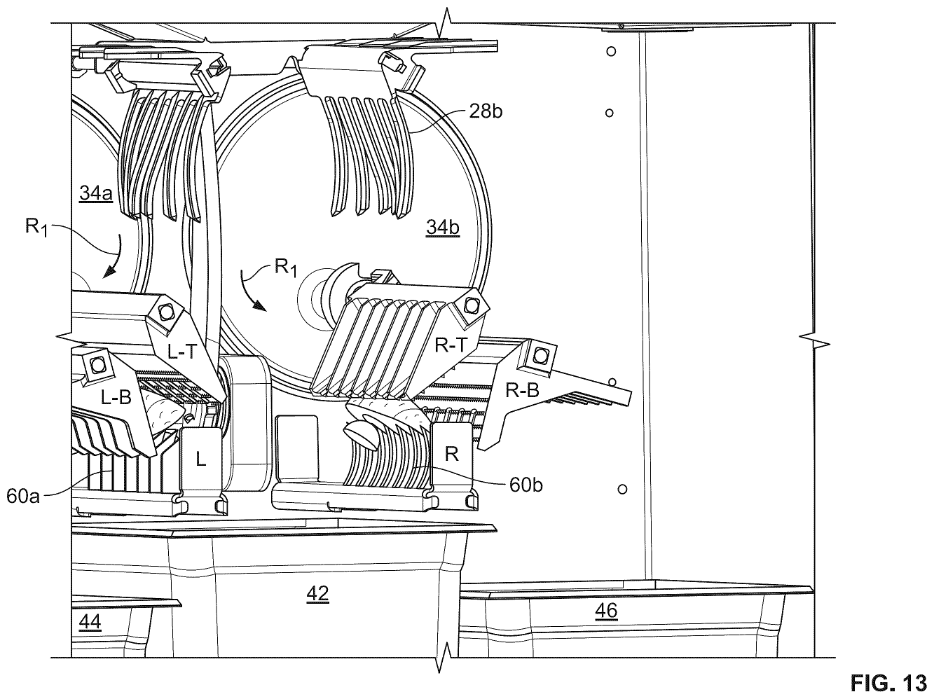

Step 172 states to core the avocado. As illustrated in FIG. 13, with the clamps in the adjusted set position from step 170, the rotators 34a, 34b start rotating (R1) further away from the center towards the outer flesh bins.

While rotating outwards (R1), due to the centered positioning of the core from Step 140, each half of the avocado (not shown) passes through a coring array 60a, 60b which dislodges the loose core (if not already ejected during step 170). Cutouts in the bottom jaw (e.g., L-B) are arranged to pass through gaps between adjacent blades in the coring array. Examples of cutout in the bottom jaw are shown in FIG. 20B.

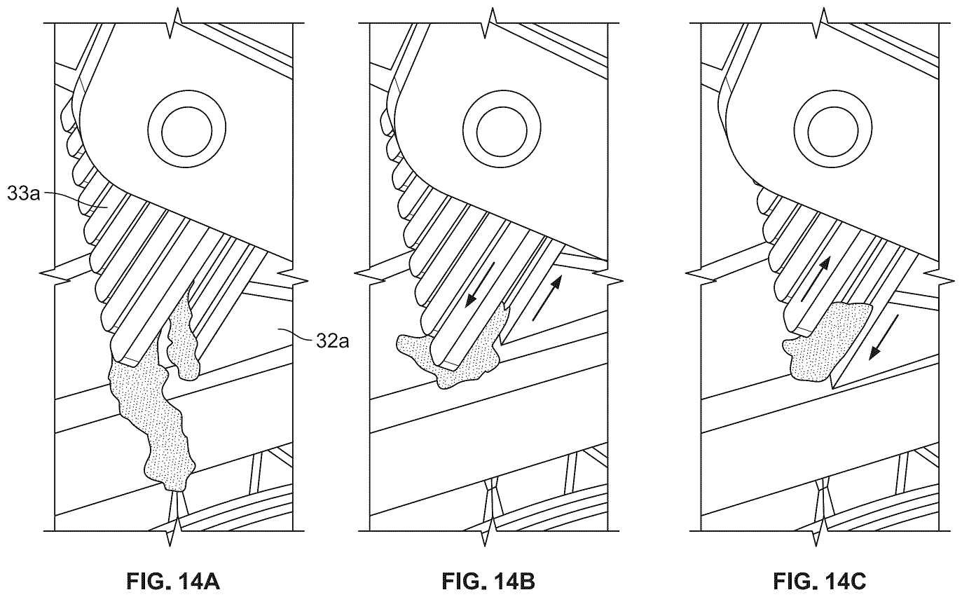

Step 180 states to eject pulp, and optionally to apply scrape action. With reference to FIGS. 14A-14C, a left side clamping assembly is shown including top and bottom jaws 32a, 33a, respectively.

FIG. 14A illustrates clamping the jaws 32a, 33b together to squeeze out all the flesh from the avocado half.

With reference to FIGS. 14B-14C, the clamp actuators are moved to re-open the compliance between the clamps. Alternately, each jaw is urged against the opposing jaw to eject any leftover flesh in the avocado halve. This motion serves to replicate scraping the folded skin to extract maximum yield.

In embodiments, each jaw includes a surface texture or teeth to engage the skin of the avocado, and to increase traction for scraping and pulp extraction. Although the surface gripping feature and patterns may vary, an exemplary gripping texture is shown in FIGS. 20A-20B. FIGS. 20A-20B shows enlarged perspective views of the right top (R-T) and right bottom (R-B) jaws, respectively, in accordance with an embodiment of the invention. The texture comprises teeth arranged in linear arrays across the face of the jaw. Cut-outs are shown in each of the bottom and top clamp faces to accommodate (and cooperate with) the coring array blades and trapdoor fingers, respectively, as described herein.

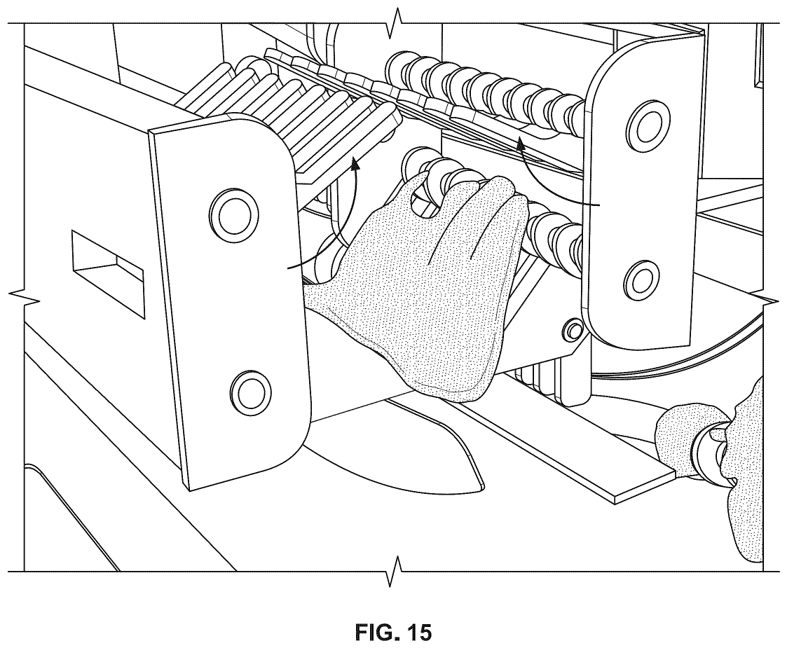

Step 182 states to open clamps to release skin. Each clamp is kept closed to retain the skin and the rotators 34 bring each clamp (including the skin) back towards the center waste bin 42. Then, with reference to FIG. 15, the top and bottom jaws of each clamp are opened to release the skin into the waste bin.

Step 190 states to eject skin from clamps.

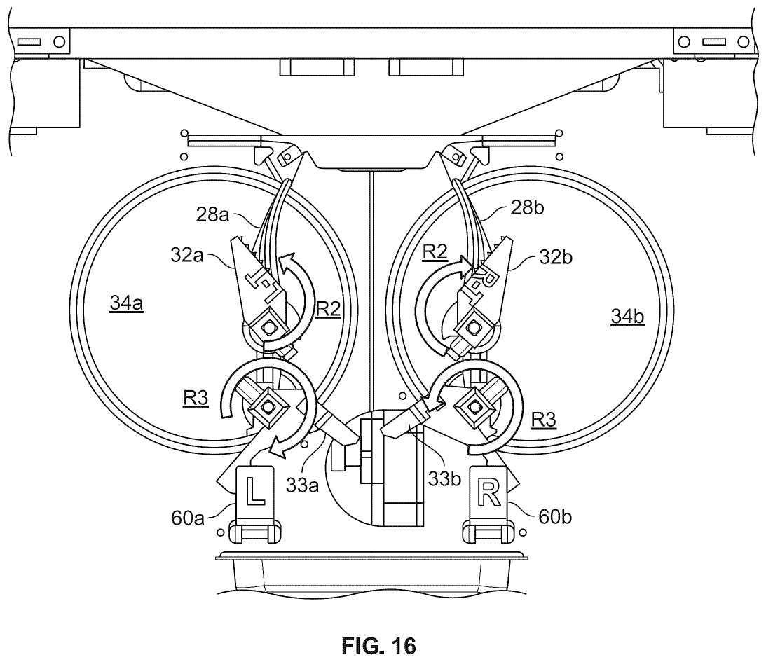

With reference to FIG. 16, this step is performed by rotating (R2) the top jaws 32a, 32b through the trapdoors 28a, 28b. In embodiments, skin ejector features (namely, the fingers) on the trapdoors pass through cutouts in the top jaws to eject any skin remaining on the top jaws into the waste bin. Examples of cutouts in the top jaw are shown in FIG. 20A.

Additionally, in embodiments, the rotators 34a, 34b are moved outwardly with the bottom jaws 33a, 33b in an angled position. This rotates (R3) the bottom jaws L-B(33a), R-B(33b) through the coring array 60a, 60b where the blades of the coring array pass through the cutouts in the lower jaw to dump any skin remaining on the bottom jaws into the waste bin. Examples of cutouts in the bottom jaw are shown in FIG. 20B.

Additional details and examples of a cutting coring and pulp extracting system are described in provisional application No. 63/694,716, filed Sep. 13, 2024, entitled “Method for Automated Extraction of pulp, juice and other products from an encapsulated fruit, produce, or seed”, which is herein incorporated by reference in its entirety for all purposes.

With reference again to the flow chart shown in FIG. 4, step 192 states to continue. This step can be performed by determining whether the next avocado should be dispensed or singulated from the loading assembly to the C2P station for processing. Software logic for proceeding can include confirming by sensor or a clock data that an avocado or part of the avocado has passed to the next stage or handoff position. Optionally, a counter maintains the number of avocados passing to the next stage for monitoring throughput, discussed herein. If ‘yes’, the method proceeds to step 120 to singulate another avocado. If not, the method is halted 194, and optionally, an operator is alerted via the dashboard 92 or otherwise to check or power off the system.

### Computer and Electronics

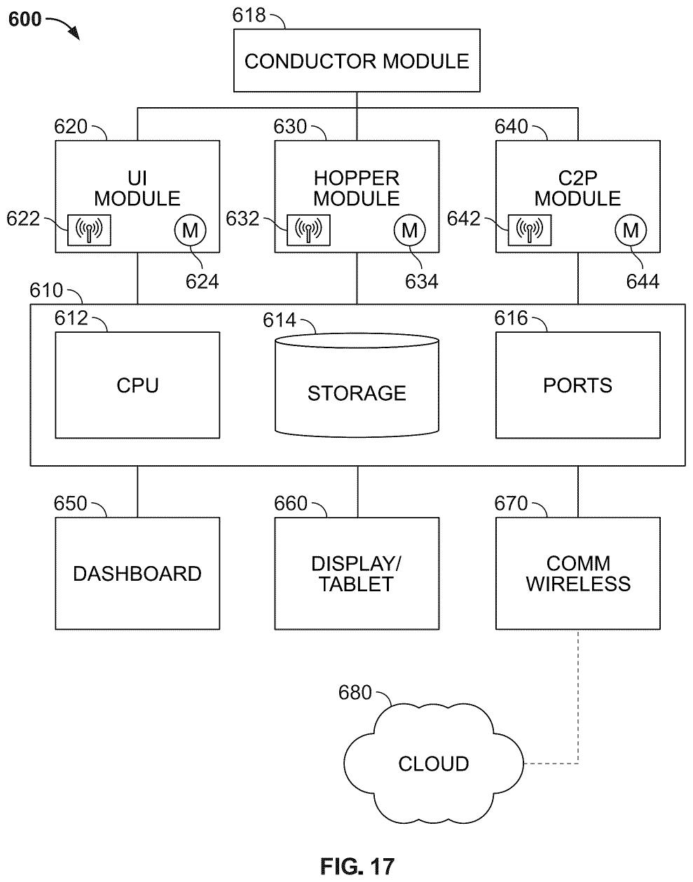

FIG. 17 is a block diagram of an avocado processing system 600 in accordance with embodiments of the invention. The system 600 is shown including a computer 610, conductor module 618, UI module 620, hopper module 630, C2P module 640, and dashboard 650.

Computer 610 is shown including a processor 612, storage 614, and ports 616 (or pins in the case of the micro-controller or PLC) for connecting with various different types of peripherals, devices and/or power. The computer may include one or more processors or a processor framework. The processor is programmed and operable to carry out the steps described herein based on firmware and software (including the various modules) stored in the computer.

In the system 600 shown in FIG. 17, each of UI module 620, hopper module 630, and C2P module 640 can include one or more dedicated sensors 622, 632, 642 and optionally motors 624, 634, and 644. The modules are operable to communicate and share information with the computer 610 including keeping track of the state of the motors, components, and throughput metrics, as described herein.

Power supplies, converters, and other electronic components can be present for carrying out the steps described herein. Some components can be dedicated to one action or module, and other components can be shared. For example, the computer may include a DC power supply to drive each of the motors of the modules. Alternatively, each module may have a dedicated power supply. Indeed, the invention may include a wide range of electronic and mechanical (including pneumatic) configurations.

Optionally, the system 600 may include a display 660 such as monitor or a touchscreen tablet.

Optionally, the system may include a wireless communication board or module 670 for communicating with mobile devices, local networks, and/or remote servers or cloud servers 680.

Although a dashboard was described above including various buttons and switches, embodiments of the invention can include a screen and optionally, a touchscreen, to control the system. A computer may be programmed and operable to show or indicate (e.g., via animation) the status of the process. The computer can be programmed and operable to keep statistics of the number avocados processed, namely, split and cored, or otherwise processed as described herein. In embodiments, a scale may be incorporated into the system to measure the weight of the fruits in the bin over time. In other embodiments, motions, timing and metrics can be controlled and detected using computer vision. Each of the assemblies may be controlled by standalone electronics or by a main computer or processor programmed and operable to carry out the functions described herein including conveying, singulating, staging, orienting, cutting, coring, peeling, and food and waste collection.

Additionally, the system may be programmed and operable for integrated data tracking for metrics including flesh yield, total avocados processed, cycle time, unripe avocado count and food safety or expiration. For example, the processor may be programmed to compute the above metrics based on sensor data for time elapsed, mass, volume, and avocado count.

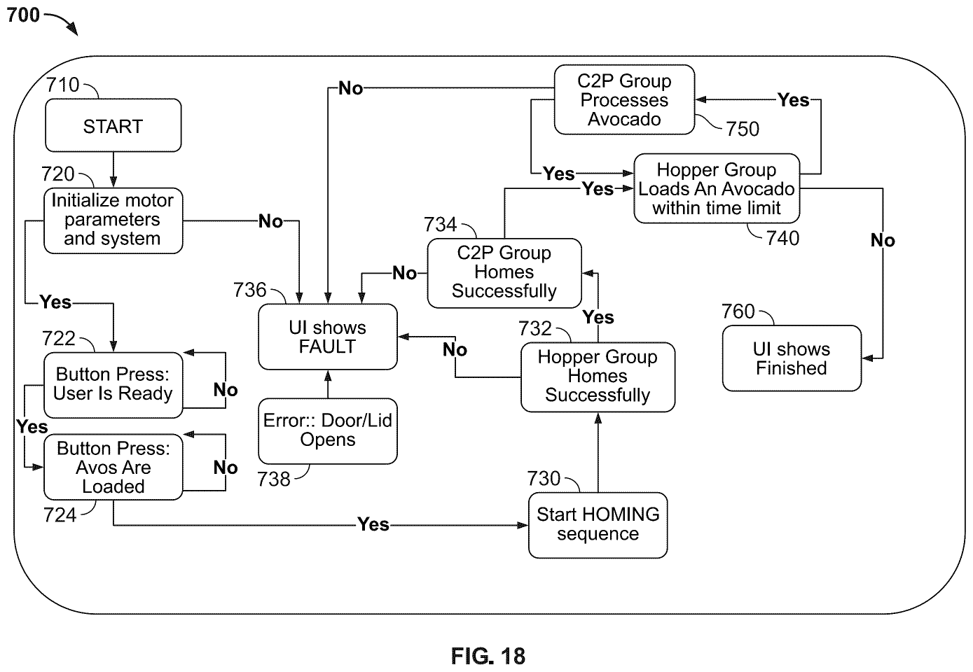

FIG. 18 is a schematic diagram of a conductor module 700 in accordance with an embodiment of the invention. The conductor module oversees the UI module 620, hopper module 630, and C2P module 640.

Step 710 is the start of the process.

Step 720 states to initialize motor parameters and system. This step is performed by the user powering on the motors, electronics, and computer of the system. This can be done by pressing power.

Steps 722, 724 state button press for (1) user is ready and (2) avocados are loaded. In embodiments, the system requires the user to press a button 2×, once for the user to ensure and acknowledge that the machine is correctly setup (e.g., are the removable parts installed, are the collection bins present, is the system clean), and a second press to indicate the avocados are loaded.

Step 730 states to start homing sequence. This step is performed by instructing all the motors and actuators to move to their home positions. For example, the trapdoors 28a, 28b should be arranged in the closed position. If any one of the hopper or C2P modules are not able to home successfully 732, 734, an error is reported. If the error comes from a component (such as a trapdoor or clamp jaw) not present or installed correctly, the system may further detect that cause and inform the user. The UI displays fault (step 736). Optionally, the door and or lid is opened by the user to fix the error (step 738).

Next, step 740 states to load an avocado. If the avocado is loaded within a predetermined time limit, the hopper module (e.g., hopper module 630) proceeds as described herein to singulate and place an avocado into the C2P processing area described above.

Next, step 750 states to process the avocado. The C2P module (e.g., C2P module 640) proceeds as described herein to cut, core and peel the avocado. Once the avocado is processed, the method returns to step 740 to load another avocado.

Loading, cutting, coring, and peeling is repeated until an avocado is not loaded within the time limit in which case the process is deemed finished (step 760). An exemplary time limit range for the loading step 740 is 30 to 120 seconds, and more preferably 20-40 seconds, and in some embodiments, 30-35 seconds.

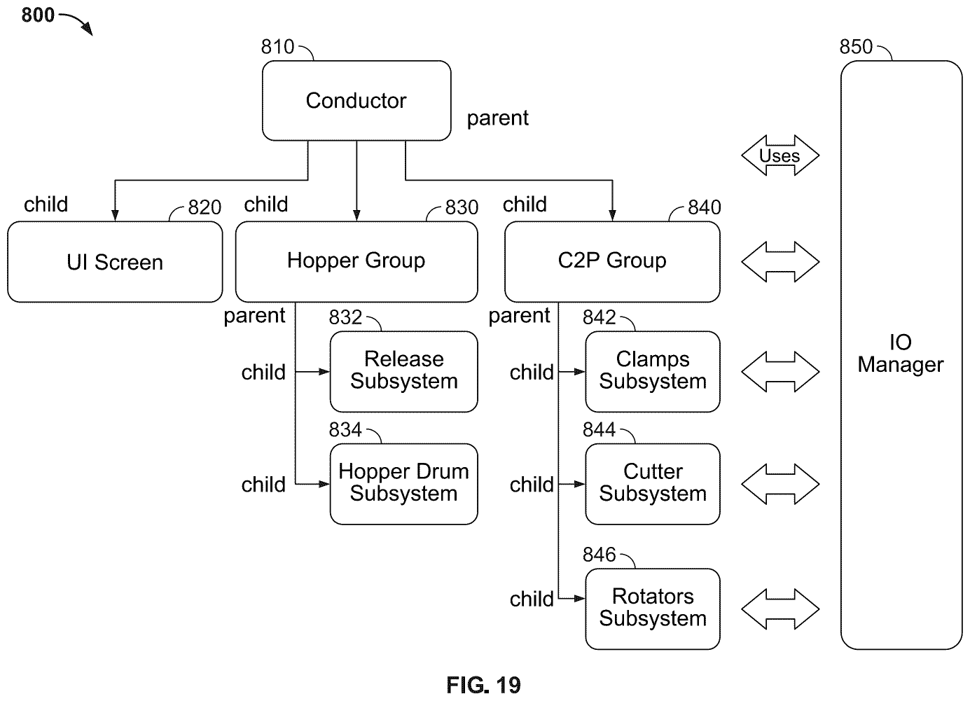

FIG. 19 is a software architecture diagram of an avocado processing system 800 in accordance with an embodiment of the invention.

The system 800 shows a conductor module for managing the submodules UI screen 820, hopper group 830, C2P group 840 and IO manager 850.

The hopper group 830 is further shown having a hopper drum subsystem 834 and release (namely, trapdoor release) subsystem 832, as described herein to control motors associated with each subsystem.

The C2P group 840 is further shown having a clamp subsystem 842, a cutter subsystem 844, and a rotator subsystem 846 as described herein to control motors associated with each subsystem.

The IO manager 850 is operable to, amongst other things, manage data from sensors and motors in order for the subsystems to perform their tasks as described herein.

In embodiments of the invention, a sensor suite comprising a plurality of sensors is arranged along the route to singulate an avocado. Examples of types of sensors are mechanical switches, a photoelectric sensor, encoders, induction sensors, and motor torque sensors.

In embodiments of the invention, mechanical sensors are located at the ‘home’ location for the clamps, rotators, and trapdoor systems. They are used as a positive homing confirmation.

In embodiments of the invention, a photoelectric sensor is situated to create a light beam across the drum drop location. When an avocado or other produce falls from the drum into the funnel, the sensor is used to determine that an avocado has been loaded.

In embodiments of the invention, encoders are on the output shafts of the clamps and rotators. These sensors are able to report the location of the clamp and rotators. This information is used to determine whether there is an avocado clamped, the hardness of the avocado, and whether there are any obstructions in the movement path.

In embodiments of the invention, induction sensors are used in the cutter system and two of them are placed in the loaded and fully unloaded positions. They are used to determine the state of the cutter and whether it is stuck or free to move.

In embodiments of the invention, motor torque sensors are located on the PCBA. These provide feedback to the motor driver about the motor's movement and ‘effort’. This sensor feedback is used to ‘home’ the systems to a hardstop, check clamp installation, and estimate actuator health.

Indeed, a wide range of sensor types can be used to trigger stages, monitor system progress and health, and compute metrics.

### Alternative Embodiments

The hardware and electronics may vary.

Examples of types of sensors include, without limitation, proximity sensors, time of flight sensors, ultrasonic sensors, retro-reflective sensors & photoelectric sensors.

Examples of types of actuators include without limitation stepper motors and servomotors. In embodiments of the invention, computer-controlled pneumatic actuators are employed to move the components for processing the avocados.

Optionally, in lieu of sensors, other mechanisms (mechanical-based) can be arranged along the route to singulate an avocado including, e.g., levers or switches along the route that are triggered when an avocado passes. The levers and switches may be designed to cause the motors to start and stop. Indeed, a wide range of trigger arrangements to control dispensing and singulation of an avocado are intended to be included within the scope of the invention.

In embodiments of the invention, the system can include additional sensors and/or vision directed at the various handoff points between stages to qualify and/or quantify attributes of the objects of interest (namely, the produce). For embodiments, for example, qualifying the object can include, but is not limited to: detecting whether the object damaged or bruised; what is the ripeness or visible exterior of the object; and what is the orientation. For embodiments, for example, quantifying the object can include, but is not limited to: detecting the weight and dimensions. Visions systems can include, e.g., camera(s) and a processor programmed with trained detection and classification models to perform the functions described herein.

In embodiments of the invention, various hardware components of the system are tracked. In one embodiment, an RFID tag is arranged on the component to be tracked. Examples of hardware components to be tracked include, without limitation, consumables such as the clamping jaws and cutting blades.

In embodiments of the invention, the system has pre-established quantified datasets for the average mechanical decay rate of each consumable or component to be tracked. As the system operates, the runtime and maturity of the components are tracked using, e.g., a unique ID sensed by the RFID receiver for each component.

In embodiments of the invention, the metrics and data tracking the system records are integrated with end customer Quick Service Restaurants (QSR) inventory and data pipelines. In embodiments of the invention, the metrics and data tracking the system records are integrated with a food service, restaurant or a commissary, or a processing plant. The metrics are uploaded to the databases, providing real time data to help monitor efficiency of operations within the kitchens.

In embodiments of the invention, the system contains additional food safety capabilities such as and not limited to UV sanitizing lamps and heated surfaces to remove pathogens on the produce it processes as well as to prevent growth of pathogens within the machine

In embodiments of the invention, the system contains cooled compartments for the storage of raw produce and useful yield, thus increasing the duration of safe storage within the machine.

Still other modifications and variations can be made to the disclosed embodiments without departing from the subject invention. For example, the avocado processing system may have more or less functional stations and components than that shown and described herein. The system may also be modified to accommodate other food objects and produce and preferably, other pitted foods such as plums, peaches, mangoes, papayas, etc. Additionally, although reference was generally made herein to cutting the avocado into equal halves, it is to be understood that the invention may be directed to cutting the avocado into two parts that are not equal in size. One half may be slightly larger than the other half.

1. An automated avocado splitting, coring and pulp extraction system comprises:
a clamping assembly to hold an avocado;
a loading assembly to load one avocado into the clamping assembly from a plurality of avocados;
a cutting assembly to cut the avocado into parts while the avocado is held in the clamping assembly; and
a food collection and holding station to hold edible parts separate from nonedible parts of the avocado.

2. The system of claim 1, wherein the clamping assembly comprises a left side and a right side, and wherein each of the left side and right side comprises a bottom jaw and a top jaw.

3. The system of claim 2, wherein the jaws of the left and right side clamping assemblies are operable to collectively form a processing area for an avocado to fall onto, and optionally wherein the processing area has a V-shape profile.

4. The system of claim 3, wherein the top jaws are moved inwards for centering and clamping the avocado against the processing area collectively formed by the lower jaws, and wherein the top jaws are moved independently or simultaneously.

5. The system of claim 4, wherein the clamping assembly is operable to detect the size of the avocado during clamping.

6. The system of claim 5, wherein the cutting assembly further comprises a blade.

7. The system of claim 6, further comprising a motor or actuator operable to separate the first half and second half of the avocado after it is cut.

8. The system of claim 7, wherein each upper and low jaws of each side are operable to squish the avocado half to a degree to at least loosen, if not eject, the seed mass from the avocado half.

9. The system of claim 8, wherein in the clamping assembly is configured and operable to apply an amount of compression based on the size detected during clamping.

10. The system of claim 9, wherein each of the left side clamp and right side clamp are operable to move the avocado half through a core extractor blade array to eject the seed.

11. The system of claim 10, wherein each of the left side and right side clamps are operable to squish the pulp from the avocado half and into the collection bin.

12. The system of claim 1, wherein the loading assembly comprises a hopper adapted to receive a plurality of avocados, and optionally, a case-size number of avocados.

13. The system of claim 12, further comprising a drum to pick up an avocado from the base of the hopper and transfer the avocado to a funnel entrance.

14. The system of claim 13, wherein the funnel directs the avocado onto a set of trapdoors.

15. The system of claim 14, wherein the trapdoors open at a variable speed, independently or together, to orient the avocado before dropping it onto the processing area of the clamping assembly.

16. The system of claim 15, wherein the trapdoors comprise two trapdoors with interlocking fingers that collectively form a concave shape that centers the avocado.

17. The system of claim 1, wherein the food collection and holding assembly comprises a first container for storing edible parts and a second container for storing nonedible parts.

18. The system of claim 1, further comprising a tracker arranged on a consumable component, optionally, wherein the tracker is arranged on a cutting blade or a clamp jaw.

19. The system of claim 1, further comprising a dashboard comprising a plurality of user input features (e.g., levers, knobs, buttons, etc.) and indicators (LEDS) to control actions (e.g., power, start stop, speed, avocado size, etc.) and show the status (e.g., on/off, status machine) of the system.

20. The system of claim 1, further comprising a computing device, power supply, and a plurality of sensors programmed and operable to control the loading, cutting and food collection and holding assemblies, and optionally, wherein the computing device is selected from a computer, PLC and micro-controller.
